(19) United States
(12) Patent Application Publication
(10) Pub. No.: US 2022/0306420 A1
(43) Pub. Date: Sep. 29, 2022

(54) METHODS AND APPARATUS TO REDUCE CONDENSATION IN A TRACK

(71) Applicant: Sandar Industries, Inc., Atlantic Beach, FL (US)

(72) Inventors: Peter A. Rodriguez, Jacksonville, FL (US); Craig Austin, Jacksonville, FL (US); Paul Mellion, Jacksonville, FL (US)

(21) Appl. No.: 17/700,384

(22) Filed: Mar. 21, 2022

Related U.S. Application Data
(60) Provisional application No. 63/165,193, filed on Mar. 24, 2021.

(51) Int. Cl. B65H 35/00; B01D 53/26

(52) U.S. Cl. CPC B65H 35/00; B01D 53/26

(57) ABSTRACT

Methods and apparatus for reducing condensation in a track. An electric device continuously heating compressed air to a regulated temperature is mounted adjacent to a portion of a track associated with a tape delivery assembly. A flexible hose assists with regulating the air flow to expel and repel debris. Tee fittings are used to provide extra flexibility to adapt to various pipe sizes.

### CROSS REFERENCE TO RELATED APPLICATIONS

The present application claims the benefit of Provisional Patent Application Ser. No. 63/165,193 filed Mar. 24, 2021; the entire contents of which are hereby incorporated by reference.

### INCORPORATION BY REFERENCE TO RELATED APPLICATIONS

The present application references the U.S. Pat. Nos. 5,046,675, 5,467,937, 6,575,395, Ser. Nos. 12/655,053 and 16/849,297 the entire contents of which are hereby incorporated by reference.

### FIELD OF THE DISCLOSURE

The present disclosure relates to methods and apparatus for reducing condensation in a turn-up track. This invention relates generally in a first sense to the field of devices, apparatus, systems, and methods of effecting the high-speed severing and transfer of a rapidly advancing paper web from a rotating full spool onto an empty spool, and more particularly where such an operation is performed with a dispenser that has a modular design having automated and/or manual operational modules that dispenses a turn-up tape construct from a dispensing track. More particularly, the invention relates to modular turn-up tape dispensers and methods for dispensing transfer tape for use in paper web severing/transfer methods, wherein apparatus and methods are employed to reduce condensation in the track used for dispensing the turn-up tape which affords numerous benefits including the reduction of accumulated dust deposits, cost of the processing and safety of operations.

### BACKGROUND OF THE DISCLOSURE

Turn up Tape Delivery Assemblies like those described in U.S. Pat. Nos. 5,467,937A and 6,575,395B2 may be susceptible to an accumulation of moisture due to condensation from the relatively humid environments that they may be employed in. In when the metal and plastic components are cooler than the surrounding air that is often laden with moisture. High humidity results from the evaporation of water from the paper sheet itself, or from steam escaping the repulper in the vicinity. When this moisture condenses on the Tape Delivery Assembly, it can cause a variety of issues. Airborne debris, such as dust or fibers can adhere to the moisture and accumulate into a cake that interferes with the turn-up band. The moisture may make its way into the guideway and cause the paper band to swell and jam. It is accordingly important to have methods and apparatuses that may o reduce or eliminate condensation by warming the tape delivery assembly.

### SUMMARY OF THE DISCLOSURE

Accordingly, the present invention provides a more efficient method and apparatus to forcibly expel debris and prevent condensation by heating the guideway with heated compressed air.

When the amount of contamination is intolerable, some embodiments of turn-up systems that utilize a band presented by a track or guideway may utilize flexible aprons to protect the guideway. Some embodiments may augment the effect of the flexible apron with compressed air introduced inside the guideway with the intent of expelling or repelling the contaminates from the path of the exiting band. Still others may seek to combat condensation by heating the track or guideway with heated air provided by a blower. Each of these solutions in isolation may be inadequate for various reasons.

Flexible aprons may be adequate in conditions of light to moderate contamination by solids or overspray when the accumulations can be dislodged and cast off by the periodic, forceable exit of the band from the track or guideway. However, in conditions of heavy debris or moisture deposited by gravity, air currents or overspray, the accumulation may withstand this periodic dislodging and casting off. The result is the track contamination build up may continue to accumulate to significant amounts.

Aprons may actually contribute to moisture contamination by presenting a second surface along which condensed or sprayed moisture may be wicked into the guideway.

The addition of compressed air to the interior of the guideway, which is exhausted between the apron and the lip of the guideway may cool the guideway encouraging direct condensation. This cooling effect may be the result of the dissipation of heat energy by the expansion of the released compressed air and may encourage condensation.

Blowers used to heat the guideway may be inefficient and only work for relatively short distances from the blower nozzle because the turbulence mixes the heated air with ambient air very quickly. In some examples, an effective countermeasure may be to increase the temperature of the heated air. In some examples, however, this can overheat the guideway, the band, and surrounding equipment.

In some examples, another solution may be the use of heaters bonded to the structure of the guideway or its support members. Although conduction via contact may be an efficient means of transferring heat as contrasted with convection from hot air, the practical installation of bonded heaters may present problems of multiple heater sections requiring multiple control and safety temperature sensors and power cables. The result may be that all these issues may complicate the installation and multiply the possible points of failure and troubleshooting effort. And heating alone may not expel or repel debris at the lip of the apron. Heating without a compressed air system may only evaporate the water, leaving any captured debris adhered to the surfaces, contributing to its accumulation.

A solution involving distribution of compressed and heated air to directed locations may have numerous advantages including: A) that the compressed air may be delivered to the guideway by simple piping, B) that such a solution may be accomplished with one compact heater and control system mounted in an accessible location, C) that due to the delivery of heated compressed air directly where it is needed, losses may be reduced and less energy may be required and D) that lower operating temperatures may reduce the hazards operators may be exposed to when operating or servicing the paper machine or turn-up system, this may further reduce the chance of overheating adjacent equipment.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an embodiment of an apparatus to reduce condensation in a turn up tape application track.

FIG. 2 illustrates a cross section of an embodiment of an apparatus to reduce condensation in a turn up tape application track.

FIG. 3 is an illustration of a paper processing system where a new spool has been set up for paper web transfer.

FIG. 3A is an enlarged view of an exemplary adhesive bead and paper construct for turn up.

FIG. 4 is an illustration of a paper processing system where the adhesive and paper configuration are approaching the nip.

FIG. 4A is an enlarged view of an exemplary adhesive bead and paper construct as it approaches the nip.

FIG. 5 is an illustration of a paper processing system where the adhesive and paper configuration are compressed between the new spool and the reel drum.

FIG. 5A is an enlarged view of an exemplary adhesive bead and paper construct as it is compressed to release adhesive through the paper.

FIG. 6 is an illustration of a paper processing system where the adhesive saturated paper grabs the advancing paper web.

FIG. 6A is an exploded view of an exemplary adhesive saturated paper construct as it grabs the advancing paper web.

FIG. 7 is an illustration of a paper processing system where turn up has occurred.

FIG. 7A is an exploded view of an exemplary paper processing system where turn up has occurred.

FIG. 8 is an illustration of an apparatus to reduce condensation on an applicator as it is engaged with a paper spool.

### DETAILED DESCRIPTION

The present disclosure provides generally for methods to reduce condensation in a track and apparatus to perform these methods.

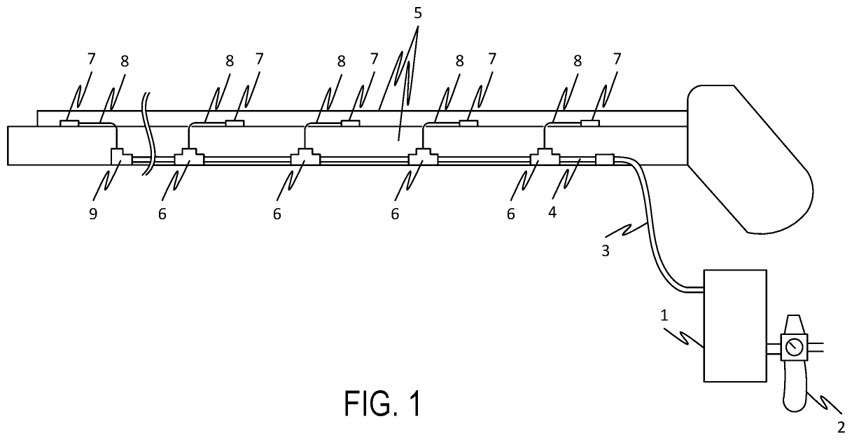

Referring now to FIG. 1, an example of the present disclosure is shown. An electric device 1 that continuously heats compressed gas to a regulated temperature may be mounted adjacent to the end of the guideway in a location conveniently accessible by operators and maintenance personnel. In some examples, the regulated temperature may be kept at less than 120 degrees Fahrenheit (49 degrees Celsius) to protect workers from being scalded by hot temperatures.

The electric device 1 may be supplied with compressed gas that passes through a filter and water separator 2. In some examples, the compressed gas may be compressed air. A flexible hose 3 may be conveniently routed from the discharge of the heater to the near end of the guideway's supporting structure and may be connected to ridged piping 4 of generous diameter (preferably ¾″ or 22 mm pipe series) mounted to and parallel with the tape delivery assembly 5 described in previous patents filed by the inventive entity. The large diameter may be selected for its usefulness as a plenum to uniformly distribute the pressure and flow of compressed air along the entire length of the guideway.

The large pipe may be fitted with tee fittings 6 at regular intervals corresponding to ports 7 provided along the guideway. Reducing fittings may be used to adapt the large pipe size to smaller, flexible tubes. In some examples these smaller tubes may be ¼″ or 6 mm. The small tubes 8 may be cut to roughly the same length and may be routed from the large tube to fittings installed in the ports of the guideway in a one-to-one correspondence. In this way, the pressure and flow may be delivered in substantially equal measure to each port.

In some examples, it may be desirable to avoid branching for some ports but not all as it may cause an unequal distribution. An exception to this example may be that it may be functional to determine that some portions of the guideway do not require a full measure of protection, such as those sections outside of the area most subject to contamination.

It may be anticipated that by using a large diameter pipe as a reservoir, only one heater may be required, in which case the large pipe may be terminated in a reducing fitting for the small tube. An elbow fitting 9 may be preferred for uniformity. However, the proportions of pressure and flow required, and the length of the tape delivery assembly may require two heaters, in which case, a desirable the arrangement of the assembly would be nearly symmetrical about its midpoint.

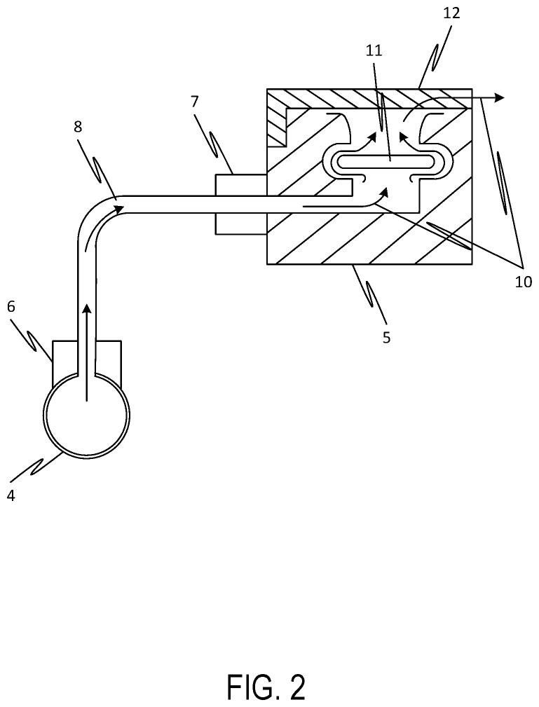

Referring now to FIG. 2, a cross sectional view of an example system to reduce condensation in a turn up paper dispensing track is illustrated with an exemplary flow diagram depicting the flow of heated compressed air. Specifically, FIG. 2 illustrates how the heated compressed air may be delivered to the tape delivery assembly, and how it may flow to expel and repel debris. Referring to FIG. 2, the elements of the ridged piping 4, the tee fittings 6, the ports 7, and small tubes 8 as illustrated in FIG. 1 are depicted. Furthermore, with arrows 10 the air flow around the band 11 and out between the apron 12 of the tape delivery assembly 5 may be depicted.

In some examples, a water drying stage may be added after a water separator in the compressed air system. The water drying stage may comprise a desiccant in some examples. In other examples a refrigeration based drying system may be used. In still further examples, the compressed gas may not be compressed air, but rather a cryogenically produced gas such as nitrogen or inert gasses.

In some examples, the plenum system comprised of tubes and orifices, or nozzles may be attached to the track system with clamps and fasteners. In some other examples, the components of the gas distribution system and the tape delivery system may include elements to hold the components with fasteners with through holes and tapped holes. In other examples, the gas distribution may be affixed with adhesives. In still further examples, the gas distribution system may be welded to the tape delivery system.

In a different type of example, the body of the tape delivery system may be designed to accommodate channels, with the characteristics of the piping system as has been described, being cut into the body to accommodate the delivery of heated, dried compressed air. In some examples, the body may be split to accommodate a sealing surface and seal. The split body may have a component side with channels to direct the compressed gas to appropriate orifices in the other side to spray compressed air into the track.

### Paper Production Example

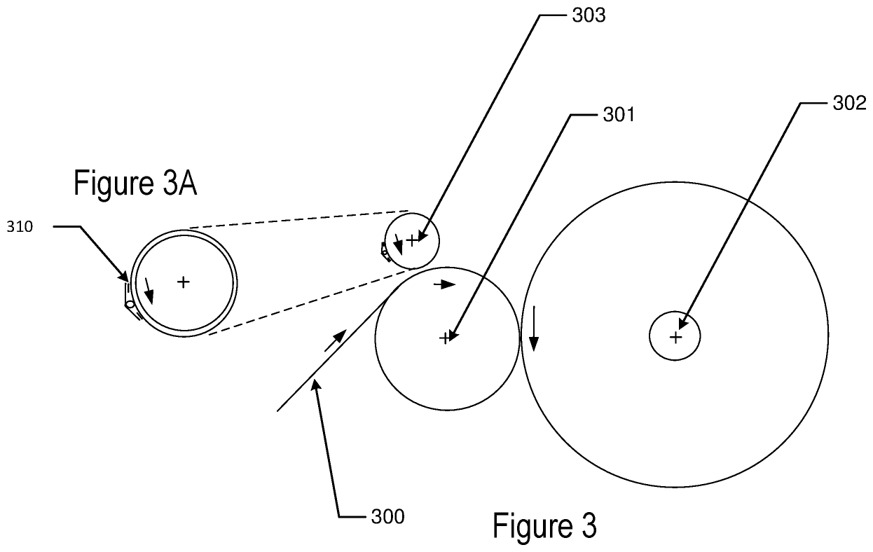

In some examples, the tape delivery system with drying components configured to it may be used in concert with paper production equipment and the application of turn up tape constructs. Referring to FIG. 3, a starting step of a paper turn up process utilizing the concepts of the present specification is illustrated. In a first (starting) step an operator has prepared the adhesive and paper turn up construct on a new spool 303. The environment of paper production may have significant levels of both dust and humidity, so the tape application may operate with the gas flow and heating configured to ensure that the application equipment remains free of dust and humidity. The new spool 303 may be used to take up the new paper web 300 as it is moved by the reel drum 301 in the direction as shown by the arrows. At the starting step the old spool 302 is approaching its capacity to take up the paper web 300. In the inset figure, FIG. 3A an enlarged view of the new spool 303 is illustrated. on the surface of the new spool paper turn up tape structure 310.

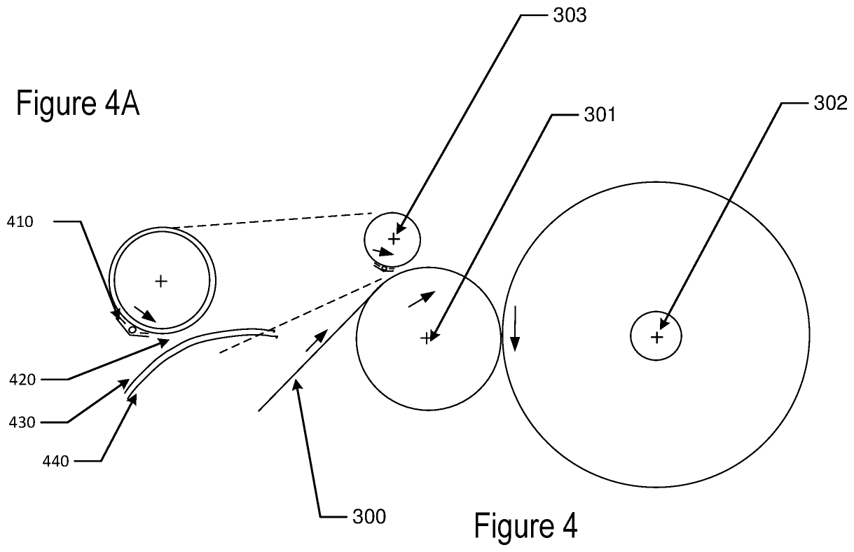

Referring now to FIG. 4, the new spool 303 approaches the nip as it moves towards the reel drum 301. The paper web 300, is still wrapping to the old spool 302. As displayed in FIG. 4A, the paper turn up tape structure 410 sits on the surface of the new spool 303. As the new spool approaches the nip 420 it will contact the paper web 430 which is upon the reel drum surface 440 and be rotated as shown by the arrows. Rotation may be accomplished, for example, via an electric or air powered motor (not illustrated). The rotation may bring the paper turn up tape structure 410 into the nip. The applied paper tape turn up construct may include portions that are coated with adhesive that interacts with the advancing paper web as it is brought into the nip.

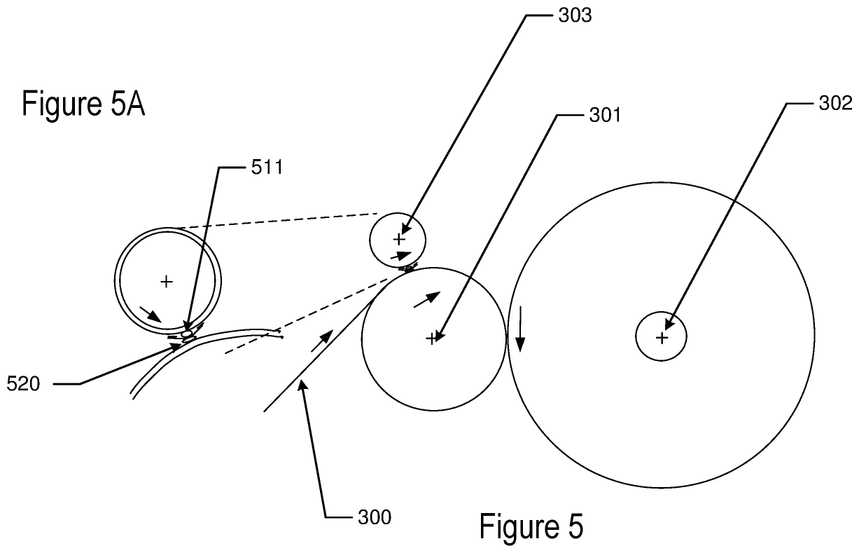

As illustrated in FIGS. 5 and 5A, as the new spool 303 continues to advance towards the nip 520 with the paper web 300 attached to the adhesive 511 the turn-up process begins. The paper web 300 may be attached both to the new spool 303 and the old spool 302 as it is advanced by the drum reel 301.

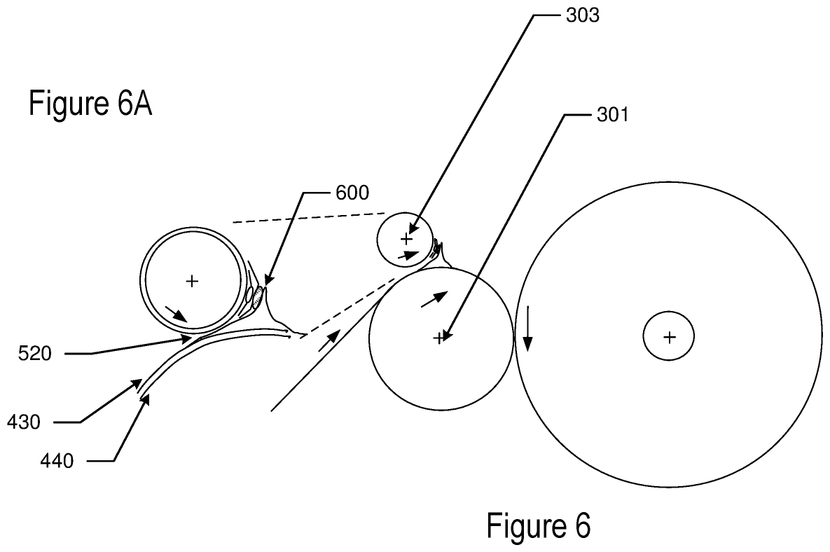

Proceeding now to both FIGS. 6 and 6A, the adhesion of the paper web 600 as the reel drum 301 rotates and lifts the paper toward the new spool 303 is illustrated. The adhesive location is rotating out of the nip 520 as new paper from the paper web 430 advances on the reel drum surface 440 while some material of the paper web advances to the old spool. It may be important that the adhesive of the turn up tape be able to hold the large forces that are being put on it during this turn up process, and therefore it is important that the surface of the adhesive and the new spool was as clean and moisture free as possible during application of the turn up tape construct. The apparatus to reduce condensation/moisture and particulate build up may aid in this goal.

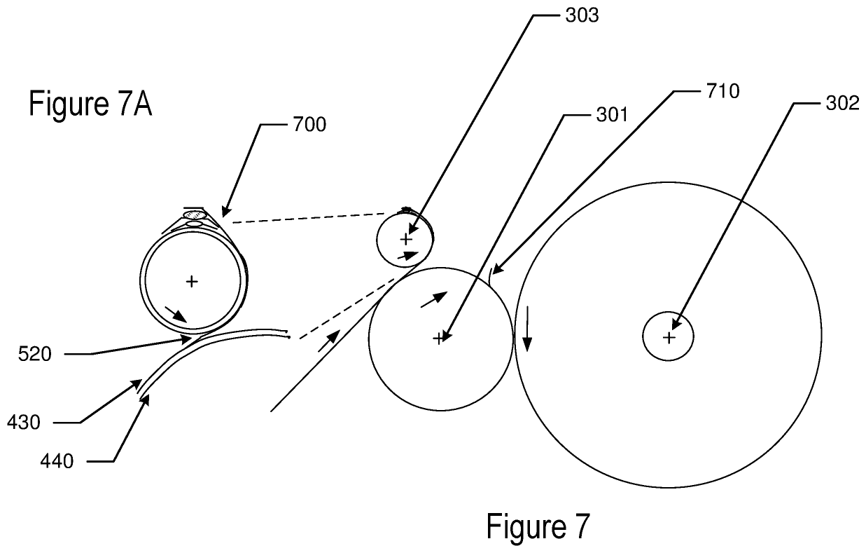

Proceeding now to both FIGS. 7 and 7A, the adhesion of the paper web 700 as the reel drum 301 rotates and lifts the paper toward the new spool 303. The adhesive location is rotating out of the nip 520 as new paper from the paper web 430 advances on the reel drum surface 440. As the new spool continues to advance with the paper web attached to the adhesive it may eventually tear or burst the paper web 700 away from the last portion 710 of the paper web that is rolling onto the old spool 302. This completes the turnup process. The old spool 302 may be moved out of the region of the reel drum 301. As the old spool 302 is moved out of the region the new spool may continue to pick up paper from the paper web 700 and be moved into the location that the old spool had occupied before it was moved.

In some examples, it may be apparent that it is important to apply the turn up tape construct in such a manner that its adhesive surfaces are kept clean of both dust and humidity before it may be applied to a spool surface. According to the present disclosure, there are apparatus and methods to configure the tape dispensing apparatus to reduce or eliminate dust and humidity with compressed air flow and in some examples heating of the compressed air.

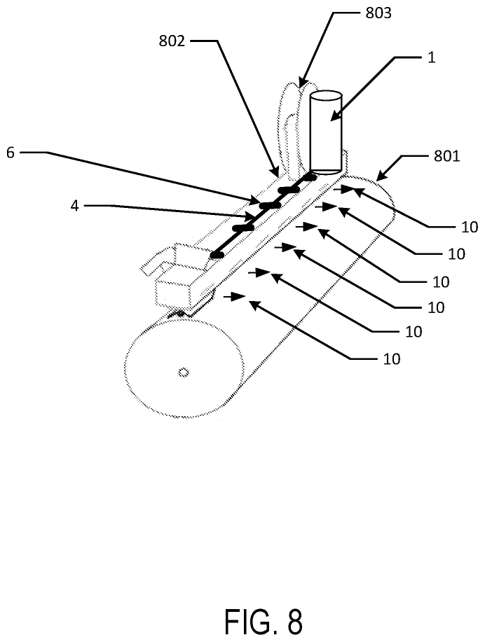

Referring to FIG. 8, an illustration of an apparatus to support an operator in the placement of the paper tape turn up structure is provided including a paper spool that the paper turn up structure may be applied to. An operator may engage a new spool 801 with an apparatus 802 to apply the adhesive and paper structure as described herein. The apparatus 802 illustrated in FIG. 8 is of an exemplary nature and many of the various types of apparatus that may be used to apply paper turn up tape constructs may equivalently be used and also equipped with components to provide compressed gas and heating.

A paper tape construct, which may be stored on a paper tape spool 803 may be affixed to the new spool 801. The apparatus 802 may include the drying system as has been discussed including the electric device 1 which may control the heating and gas flow systems. The gas may be distributed through the ridged piping 4 and tee fittings 6 to various points within the tape application system to have gas flow emitted from the device as illustrated with the arrows 10. The gas flow may be heated.

In some examples, nozzles of various designs may be used to release the compressed gas into the track of the paper delivery system. In some examples, the nozzles may have a spray pattern, in other examples the nozzles may direct a focused flow at a critical area.

In some examples, the turn-up tape delivery system may comprise a heated, dried, and compressed gas delivery system and it may be positioned in an appropriate location in proximity to a paper web spool and a paper web in a paper making process. The compressed air may flow before during and after a turn-up tape application and a following turn-up as the paper web is transferred from one spool to another. The compressed air or gas that is flowing during these processes may both dry the surfaces of the track used to advance the turn-up tape as well as ejecting and keeping particles away from the track.

One general aspect includes a method of preparing a turn-up tape delivery system including affixing a compressed gas delivery system to the turn-up tape delivery system, wherein the compressed gas delivery system comprises a plenum for distribution of heated gas to a plurality of locations on a track of the turn-up tape delivery system. Implementations may include one or more of the following features. The method where the plenum may include a plurality of different sized tubes. The method where the plenum may include tee fittings. The method where the compressed gas is compressed air. The method where the compressed gas is routed through a heating element. The method where the compressed gas is further routed through a water separation element. The method where the compressed gas is further routed through a drying element. The method where the heating element heats the compressed gas where a temperature of the compressed gas is lower than approximately 120 degrees Fahrenheit (49 degrees Celsius). The method where the plenum may include within a body of the turn-up tape delivery system. The method where the plenum may include channels cut into the body of the turn-up tape delivery system. Implementations of the described techniques may include hardware, a method or process, or computer software on a computer-accessible medium.

One general aspect includes an apparatus for delivering a turn-up tape in a paper production system including affixing a compressed gas delivery system to the turn-up tape delivery system, wherein the compressed gas delivery system comprises a plenum for distribution of heated gas to a plurality of locations on a track of the turn-up tape delivery system. Other embodiments of this aspect include the apparatus where the plenum may include a plurality of different sized tubes. The apparatus where the plenum may include tee fittings. The apparatus where the compressed gas is compressed air. The apparatus where the compressed gas is routed through a heating element. The apparatus where the compressed gas is further routed through a water separation element. The apparatus where the compressed gas is further routed through a drying element. The apparatus where the heating element heats the compressed gas where a temperature of the compressed gas is lower than approximately 120 degrees Fahrenheit (49 degrees Celsius). The apparatus where the plenum may include within a body of the turn-up tape delivery system. The apparatus where the plenum may include channels cut into the body of the turn-up tape delivery system.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

In certain implementations, multitasking and parallel processing may be advantageous. Nevertheless, it will be understood that various modifications may be made without departing from the spirit and scope of the claimed disclosure.

What is claimed is:

1. A method of preparing a turn-up tape delivery system, the method comprising affixing a compressed gas delivery system to the turn-up tape delivery system, wherein the compressed gas delivery system comprises a plenum for distribution of a compressed gas to a plurality of locations on a track of the turn-up tape delivery system; and
wherein the compressed gas is flowed through the compressed gas delivery system during one or more of a period before application of a turn up tape to a paper spool, during application of a turn up tape to a paper spool or after application of a turn up tape to a paper spool.

2. The method of claim 1 wherein the plenum comprises a plurality of different sized tubes.

3. The method of claim 1 wherein the plenum comprises tee fittings.

4. The method of claim 1 wherein the compressed gas is compressed air.

5. The method of claim 1 wherein the compressed gas is routed through a heating element.

6. The method of claim 5 wherein the compressed gas is further routed through a water separation element.

7. The method of claim 6 wherein the compressed gas is further routed through a drying element.

8. The method of claim 5 wherein the heating element heats the compressed gas wherein a temperature of the compressed gas is lower than approximately 49 degrees Celsius.

9. The method of claim 1 wherein the plenum is comprised within a body of the turn-up tape delivery system.

10. The method of claim 9 wherein the plenum comprises channels cut into the body of the turn-up tape delivery system.

11. An apparatus for delivering a turn-up tape in a paper production system, the apparatus comprising affixing a compressed gas delivery system to a turn-up tape delivery system, wherein the compressed gas delivery system comprises a plenum for distribution of a compressed gas to a plurality of locations of a track of the turn-up tape delivery system.

12. The apparatus of claim 11 wherein the plenum comprises a plurality of different sized tubes.

13. The apparatus of claim 11 wherein the plenum comprises tee fittings.

14. The apparatus of claim 11 wherein the compressed gas is compressed air.

15. The apparatus of claim 11 wherein the compressed gas is routed through a heating element.

16. The apparatus of claim 15 wherein the compressed gas is further routed through a water separation element.

17. The apparatus of claim 16 wherein the compressed gas is further routed through a drying element.

18. The apparatus of claim 15 wherein the heating element heats the compressed gas wherein a temperature of the compressed gas is lower than approximately 49 degrees Celsius.

19. The apparatus of claim 11 wherein the plenum is comprised within a body of the turn-up tape delivery system.

20. The apparatus of claim 19 wherein the plenum comprises channels cut into the body of the turn-up tape delivery system.
